(19) United States
(12) Patent Application Publication
(10) Pub. No.: US 2012/0223165 A1
(43) Pub. Date: Sep. 6, 2012

(54) Method for Obtaining Microcrystalline Cellulose from Residues Derived from Acid Delinting of Cottonseed

(76) Inventor: Liliana Graciela Buente Alonso, Buenos aires (AR)

(21) Appl. No.: 13/348,150

(22) Filed: Jan. 11, 2012

(30) Foreign Application Priority Data
Mar. 2, 2011 (AR) 2011 0100636

(51) Int. Cl. B02C 23/18; C08B 15/00

(52) U.S. Cl. 241/15; 127/34

(57) ABSTRACT

Raw material comprises acid residues arising from the cottonseed cleaning process, which are subject to the following series of stages: a) neutralization of such residues; b) cleaning and purification of the residue of acid linter; c) chemical treatment by means of the action of alkalis; and d) water washing and subsequent thickening by means of filters. Such residues include some fibrils and cascamen, with a marked presence of vegetal elements typical of the seed (hull and remains of the degraded vegetal structure). After washing and subsequent thickening, the material is subject to the stages of: bleaching by means of chemical agents, washing and thickening, drying and dry grinding for reducing particle size.

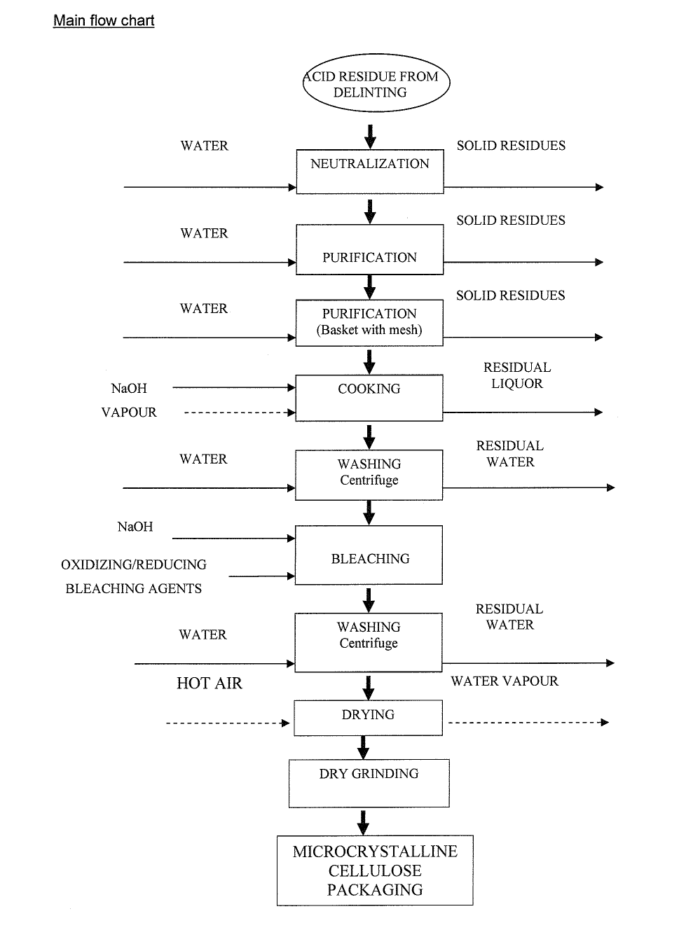

### SCOPE OF INVENTION

This invention is mainly aimed at a method for obtaining microcrystalline cellulose from residues derived from acid delinting of cottonseed, for which the physical-chemical treatment of such vegetal residues generated during the acid processing of cottonseed is carried out.

More specifically, this invention includes a process that, taking into account the physical-chemical features of the residue generated by the referred acid delinting of cottonseed, allows to directly transform it into microcrystalline cellulose.

As it is known, microcrystalline cellulose is a sub-product of cellulose suitable for many applications, such as component in the formulation of medicines, dietary supplement for food industry, cosmetology industry, bearing pharmacopoeia grade in the formulation of medicines; as well as it is involved in the composition of various products of geological, military and oil application.

It discusses an invention which defines a new industrial proceeding developed for achieving a superior result, being unpredictable and surprising even for a specialty expert. Accordingly, apart from being new, its operating and functional conception shows a clear inventive activity so that, it fulfills the conditions required by Law for being considered patent of invention.

### PRIOR ART

Various disclosures of methods for obtaining microcrystalline cellulose are known; in this respect, as an example we can cite the Argentinean patent of invention N° 202.721 of year 1975, based on a priority of Bulgarian origin, entitled “Method for Producing Microcrystalline Cellulose” in one single operation which involves hydrolyzing simultaneously with the chemical separation of the product, in the presence of dilute mineral acids, and at a temperature up to approximately 443° K, a cellulose containing more than 92% of alpha-cellulose, and 5 to 6% of beta-cellulose, a solubility of 2% to 4% in 5% sodium hydroxide solution and a viscosity of 110 has 180 mP, so that the hydrolysis criteria may be between 0.003 and 0.300 and, if necessary, cleaning and bleaching.

The Argentinean publication AR 058125 A1 of Jan. 23, 2008 is also cited, which discloses an application for a patent of invention entitled “Process for the Production of Microcrystalline Cellulose”, which comprises the preparation of a bleached pulp with a content of alpha-cellulose of 98-99% and ISO “brightness” of 90% to 92%, from fibrous raw materials with high content of alpha-cellulose (more than 80%), for the production of high purity, pharmacopoeia grade microcrystalline cellulose. The process involves a dry cleaning step at a temperature between 100° C. to 130° C. for quick impregnation of fibers (by sponge effect) and for achieving homogeneity for the subsequent purification chemical treatment. The mechanical treatment and bleaching of purified pulp are carried out, in one single stage, “Valley” type beater, in order to reduce suspension viscosity and to achieve the required bleaching for the application of microcrystalline cellulose in the pharmaceutical industry.

Publication N° 1220271, dated Jun. 23, 1999, is also cited, which discloses a Chinese patent identified under the number of application CN 98120373, entitled “Method for Producing Microcrystalline Cellulose Using Sulfated Residues of Cotton Balls”. A series of stages is disclosed, which comprises: aging, water washing, impurities removal, bleaching, dechlorination, dehydration, oven drying spray, filtering, checking and packaging. Such disclosure emphasizes that it discusses a method which requires less investment, low cost, reduction in the dose of chemical agents, reduction of environmental pollution. It is adaptable to large-scale productions and small productions.

There is not known disclosure which should teach how to obtain microcrystalline cellulose taking as raw material the residue arising from the cottonseed chemical delinting, which is an acid residue that has a degraded cellulose structure, bearing an essentially brown color and being highly pollutant due to the acid presence.

In fact, cotton, once harvested, is treated in a ginning equipment in which long fiber for spinning is obtained, the seed with linter and a residue called fibril or “cascamen”.

The cotton linter is the short fiber which remains adhered to the seed after the process of separation of seeds, also known as ginning.

In conventional processes, raw cotton is baled, seed passes to the delinting process and fibril is left as residue, being available for other uses.

Linter is basically a short fiber which in its chemical composition does not differ from the long fiber intended for the textile use.

Linter is still useful for obtaining various sub-products derived from cellulose and therefore, it is usually separated from the seed by means of mechanical and chemical processes.

The mechanical delinting process is the more widespread process and is carried out with delinting equipment using blades for first and second cut.

The chemical delinting process is also known, which basically consists in treating the seed with sulphuric acid and heat, and which main features are the following:

It is about a delinting process which is based on the separation of fibers by chemical cutting the cellulose chain, generating a cleaner and bacteriologically less contaminated seed, suitable for subsequent uses.

The residue obtained with this process has no longer the properties which define the linter in the strict sense, that is, it has stopped existing as such and it is not suitable for the production of alpha-cellulose due to the degradation produced by the acid on the cellulose chain, which has a bearing in the substantial drop of its average molecular weight and its rheopectic features.

The process itself involves the immersion of seeds in a dilute solution of sulphuric acid followed by the stages of cooking in rotary ovens.

The seeds obtained by this method are free from residual linter and sanitarily suitable for its use.

The residue generated by this process is composed of remains of hull, the product produced from linter, totally degraded with a high content of acid, and the presence of carbon residues as a consequence of the aggressiveness of the treatment received.

This process of acid chemical delinting, produces a residue which is characterized in that it has an aspect of brown fine powder, with a very short cellulose chain and rheologic properties of low viscosity.

As it is described, it is a highly contaminant residue with few or no possibilities of being used as obtained.

One of the possible uses, in a direct manner, is ph adjustment in soils with high content of alkalinity. If it is intended to be used as filler, it should be neutralized before being disposed on the ground.

### SUMMARY OF THE INVENTION

The process to which this invention is referred, is based on the novel fact that, taking advantage of the physical-chemical features of the residue generated from acid delinting and by means of a conveniently developed technique, it is possible to directly transform this residue highly contaminant to the environment into microcrystalline cellulose.

As it is known, microcrystalline cellulose is a cellulose sub-product which has a highly wide variety of uses.
One of these and perhaps the one with greater added value, is its application with pharmacopoeia grade as component in the formulation of medicines.
Its employment in food industry is also widespread, where it is used as dietary supplement substituting fats and carbon hydrates in the formulation of food with low energy-giving content.
Due to its rheologic qualities, its employment as stabilizing medium in gels and emulsions is very interesting. (Cosmetology and other industries)
Also but not less important, it has a direct application in the composition of strategic products within the military industry and oil industry.

According to the widespread process, the microcrystalline cellulose is obtained from a treatment with dilute acid or with specific enzymes of cellulose fibers with high content of alpha-cellulose coming from vegetal species of different origins and from different pulping processes.

This treatment generates the attack and dissolution of the amorphous part of the cellulose leaving as a result the part with greater crystalline arrangement which is more difficult to attack.

The final result is a cellulose with an aspect of fine, brown or considerably white, odorless and tasteless powder.

It is specially highlighted that it is basically insoluble in water, acetone, ethanol, toluene, dilute acids and solutions of 50 g/l sodium hydroxide, inert with regard to the human body and with a capacity of high compression. These features make it especially suitable for being used in tablets for medicines, as it was already said.

This invention presents as novelty that the raw material used is specifically the acid residue of the cleaning process of cottonseeds.

### BRIEF DESCRIPTION OF THE DRAWING

The drawing FIGURE is a flowchart of a method according to the present invention.

### DETAILED DESCRIPTION OF THE PREFERRED EMBODIMENT

In order to carry out the practice of the aforementioned process, with the aim of obtaining microcrystalline cellulose, by means of the chemical treatment of vegetal residues generated from the cottonseed chemical delinting, there follows a more detailed description of a series of stages defining the process of this invention for obtaining the microcrystalline cellulose from the vegetal residues generated in the acid delinting process of cottonseed and which comprises the following stages:
1. Neutralization
2. Cleaning and purification of linter acid residue
3. Alkaline conking
4. Washing/centrifuge thickening
5. Bleaching with oxidizing/reducing agents
6. Washing/centrifuge thickening
7. Drying
8. Dry grinding

### 1. Neutralization:

Neutralization is carried out in stirring tanks with a consistency ranging between 5% and 19%, by means of the addition of enough alkali for adjusting the suspension to a ph close to 7.00.

### 2. Cleaning and Purification of the Linter Acid Residue.

The neutralized suspension without being cleaned is taken to a consistency ranging between 2% and 8% and is passed through a high consistency conic centrifuge purifying equipment where heavier contaminants are extracted thereof. Then it is diluted to a consistency of 1% and is treated in a basket continuous purifying machine with a 80 to 150 mesh where finest impurities are removed therefrom.

### 3. Alkaline Cooking:

After being purified, it is concentrated by the use of centrifuge or pulp thickening filter. Finally, it is subject to cooking in a reactor by means of the use of alkaline reagents (NaOH) with a consistency between 5% and 20%, alkali concentration of 10% to 30% on dry basis of the residue to be treated, at a temperature between 90° C. and 170° C., under atmospheric pressure or under a pressure up to 11 kg/cm², during the period sufficient for removing lignine traces present in impurities that it may contain, this period can be extended to 60 and 180 minutes.

### 4. Washing/Centrifuge Thickening:

Once cooking is completed, a suspension has been formed, which shall be centrifuged and washed by means of the use of process water in centrifuge equipment designed for the obtained particle size range.

5. Bleaching with Oxidizing/Reducing Agents

The obtained, cooked and washed pulp is then subject to a oxidizing bleaching process by the use of hydrogen peroxide (H₂O₂). In order to secure the efficient contact between suspension and other reagents, a solid/liquid rate of 1/7 to 1/20 is used. The concentration of the oxidizing bleaching agent ranges between 3% and 15%, the oxidizing agent is accompanied by stabilizers and NaOH for regulating ph.

Once the addition of the reagents is completed, suspension heating up to between 80° C. and 170° C. is commenced, keeping the conditions from 60 to 180 minutes depending on the selected temperature.

In this stage, the process allows the possibility of adding another reducing stage, which uses reagents like sodium hydrosulphite (Na₂S₂O₄) (or a mixture of 50%/75% of sodium hydrosulphite (Na₂S₂O₄) plus 50%/25% of sodium acid sulphite (NaHSO₃) with the aim of removing the color of microfibers by reducing the colored quinonic structures.

The typical conditions of use of this type of bleaching involve treating the suspension with a consistency between 2% and 8%, with a reducing reagent load ranging between 0.4% and 3.5%, average temperature of 60° C. to 170° C., ph between 5.5 and 7 and a retention time comprised between 1 h and 3 h at the mentioned temperature.

### 6. Water Washing/Centrifuge Thickening:

Once cooking is completed, the solid obtained is centrifuged and washed by the use of clean process water in an equipment designed for such use.

### 7. Drying:

The solid obtained should be dried in equipment specially designed, given its particle size. It is subject to a countercurrent hot air cross-flow at an average temperature between 80° C. and 120° C.

### 8. Dry Grinding:

Once drying is completed, the material behaves as a fine powder that should be adjusted in its particle size. For this process, hammer type mills or any other type of mills that may reduce the particle size to a size between 40 μm and 70 μm are used.

### Inventive Activity

No process conceived for obtaining microcrystalline cellulose among the currently known processes propose, or even suggest, the solution arising from what is indicated in the preceding paragraphs, this is the reason why it concerns a proposal that, in addition to being novel, has a clear inventive activity when solving a flagrant problem of contamination not resolved to date by means of a technique that is going to directly and positively impact on the preservation of the environment.

### Example of the Embodiment

In order to define the advantages summarily mentioned, to which users and experts on the specialty may add many other advantages, and with the aim of facilitating the understanding of the main functional characteristics of the invented process, below an example of the embodiment is described with the specific explanation that it is not appropriate to assign to it a limiting or exclusive nature of the scope of protection of this patent of invention, but it simply has a merely explanatory and illustrative intention about the basic conception on which it is grounded.

### 1. Description of Raw Material

Raw material is constituted by vegetal residues generated in the cottonseed acid processing and has the following features:
It is a fine brown powder with the presence of some fibrils and “cascamen”.
There is a marked presence of vegetal elements typical of the seed (hull and remains of the degraded vegetal structure)
Due to the absorbent feature of cotton, a varying quantity of sulphuric acid is retained presenting an acid ph (pH 2 or less).
Average content of ashes of 4.5%
Average humidity of 35%
For a consistency of 50 g/l, it has a value of 230 cm³ of Sediment Solids in 10 minutes and 180 cm³ of Sediment Solids in 2 h.
Intrinsic viscosity lower than 300 ml/g

Following the process set forth in this patent and using one ton of a raw material as the one previously described in item 1., we can obtain the following average data:

### 2. Neutralization Stage:

Neutralization is carried out in stirred tanks with a consistency ranging between 5% and 19%, by means of the addition of sufficient alkali, the suspension adjusted to a ph close to 7.00 and by using chelating agents in quantities ranging from 0.1% to 0.5%, interferences of heavy cations were removed. In this stage no reduction was obtained as all the processed material is used in the subsequent stage.

### 3. Cleaning and Purification:

The neutralized suspension without purification is dilute to a consistency between 2% and 8% and is passed through a high consistency purifying equipment where heavier contaminants are extracted, normally with reductions of about 1%. It is then dilute to a consistency of 1% and is treated with a three-effect continuous purifying equipment with 80 mesh to 150 mesh where finest impurities are removed obtaining a material with brown color but with a content of black spots which are fairly perceptible, the total loss of both processes amounts to 9% to 11%.

### 4. Alkaline Cooking:

After being purified, it is concentrated by the use of pulp thickening filter. Finally, it is subject to cooking in a reactor by the use of alkaline reagents (NaOH) with a consistency between 5% and 15%, alkali concentration of 10% to 20% on dry basis of the solid to be treated, at a temperature between 60° C. and 170° C., under atmospheric pressure or under a pressure up to 11 Kg/cm², during the period sufficient for removing lignine traces present in impurities that it may contain, this period can be extended to between 60 and 180 minutes. The experience obtained in this stage gives a product with a more marked brown tonality where black spots are perceptible only using a magnifier with a magnification of 120. The dry residue of the product in this stage presents a clear trend to pelletization without the presence of fibrils. The total loss of this stage is of about 7% to 11%.

### 5. Washing/Centrifuge Thickening

Once cooking has been completed, the suspension is centrifuged and washed by the use of process water in equipment designed for such use. Average losses amount to 5%, depending on the efficiency of the equipment.

6. Bleaching with Oxidizing/Reducing Agents:

In this point of the process there are microcrystals with varying size, which once cooked and washed are then subject to a first oxidizing bleaching process by the use of hydrogen peroxide (H₂O₂). In order to secure the efficient contact between fibers and reagents, and to obtain a better mix, a solid/liquid rate within the range of 1/7 to 1/20 that may allow operation, is used. The concentration of the oxidizing bleaching agent ranges between 3% and 9%, and the oxidizing agent is accompanied by stabilizers and NaOH as ph regulator.

Once the addition of reagents has been completed, suspension heating up to between 60° C. and 130° C. is commenced, keeping conditions for 60 to 180 minutes, depending on the temperature selected for the operation.

In this stage a first product with a intermediate whiteness grade can be obtained, which can be considered an A1 sheet, industrial grade product.

Finally, other more oxidizing stage is added to this stage, using as reagent Sodium Hypochlorite in a concentration ranging from 4% to 8% at a temperature in the range of 50° to 80° C. and with a time of reaction of ⅓ hours. Under these conditions, a product with a finer granulometry is obtained, with a whiteness grade of 70% to 80%, and with a total reduction in both stages of 10% to 14%.

### 7. Final Water Washing/Centrifuge Thickening

Once bleaching is finished, the product is washed and centrifuged in continuous equipment.

### 8. Drying:

The product is fitted to its final humidity by means of countercurrent hot air cross-flow at an average temperature between 80° C. and 120° C.

Upon completion of the drying stage, a granulated product with a clear trend to pelletizing and with a whiteness grade of 70% to 80% was obtained. The partial loss of this stage is about 3% to 5%.

### 9. Dry Grinding:

Once drying has been completed, the granulated material should be adjusted in its particle size. For this process, hammer type mills or any other type of mills that may reduce the particle size between 40 μm and 70 μm are used. The reduction of this stage is about 3% to 5%.

### 10. Global Yield

The applied process made it possible to determine a total reduction of 45%, therefore the global yield of the process is 55%, being able to be optimized until reaching a 65% because of improvements in the efficiency of the equipment of the process.

As a final result a product with the following features was obtained:
Whiteness of 70% to 80%.
Particle size with a 95% retention in 200 mesh.
Intrinsic viscosity range between 150 ml/g and 200 ml/g.
Heavy metal content within the limits required by pharmacopoeia.
Insoluble in 50 g/l NaOH.
Insoluble in water, acetone, ethanol and toluene.
High compression capacity

1. A method for obtaining microcrystalline cellulose from residues derived from acid delinting of the cottonseed, characterized in that the raw material comprises acid residues arising from the cottonseed cleaning process, which are subjected to the following series of stages: a) neutralization of such residues; b) cleaning and purification of the acid linter residue; c) chemical treatment by the action of alkalis; and d) water washing and subsequent thickening by using filters.

2. A method for obtaining microcrystalline cellulose from residues derived from acid delinting of the cottonseed, as claimed in claim 1, characterized in that the acid residues arising from the cottonseed cleaning process include some fibrils and cascamen, with a marked presence of vegetal elements typical of the seed.

3. A method for obtaining microcrystalline cellulose from residues derived from acid delinting of cottonseed as claimed in claim 1, characterized in that, after washing and subsequent thickening, the material is subjected to the stages of:
bleaching by the action of chemical agents;
washing and thickening;
drying; and
dry grinding for reducing particle size.

4. A method for obtaining microcrystalline cellulose from residues derived from acid delinting of cottonseed as claimed in claim 3, characterized in that the bleaching stage is carried out in an aqueous alkaline medium and oxidizing/reducing chemical agents at a temperature in the range of 70° C. to 120° C.

5. A method for obtaining microcrystalline cellulose from residues derived from acid delinting of cottonseed as claimed in claim 3, characterized in that the drying stage is performed by countercurrent hot air cross-flow, at an average temperature of 80° to 120° C.

6. A method for obtaining microcrystalline cellulose from residues derived from acid delinting of cottonseed as claimed in claim 3, characterized in that the dry grinding stage is carried out by a reducing grinding of particle size to a size that can pass through a 200 mesh.
